(19) United States
(12) Patent Application Publication
(10) Pub. No.: US 2007/0247049 A1
(43) Pub. Date: Oct. 25, 2007

(54) Field emission apparatus

(75) Inventors: Yun Li, Niskayuna, NY (US); Brian James Grimmond, Clifton Park, NY (US); Hai Lu, Niskayuna, NY (US); Pierre Andre Bui, Clifton Park, NY (US); Joseph Darryl Michael, Schoharie, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/408,888

(22) Filed: Apr. 24, 2006

(51) Int. Cl. H01J 1/00; H01J 19/06

(52) U.S. Cl. 313/311

(57) ABSTRACT

By patterning a catalyst layer in a micrometer scale and growing nanotubes on it, the emission area is formed by many small emitter islands. Each emitter island comprises finite nanotubes in a nominal density. Due to the vast amount of gaps between emitter islands, relatively more nanotubes are exposed to the edge region of the emitter, which effectively increases the average inter-spacing of nanotubes. The field shielding effect is significantly reduced this way.

### TECHNICAL FIELD

The present invention relates in general to field emitters, and in particular, to field emitters utilizing nanotubes.

### BACKGROUND INFORMATION

Cold cathode field emission occurs when the local electric field at the surface of a conductor approaches approximately 10⁹ volts per meter (v/m). In this field regime, the work function barrier is sufficiently reduced to permit electronic tunneling from the conductor band to the vacuum band, even at low temperatures. To achieve the high local fields at experimentally achievable macroscopic fields, field emission sources have typically be,en made from sharp objects, such as etched wires, micro-fabricated cones or nano-structured conductors, such as carbon nanotubes (CNTs). One problem that has been difficult to overcome is that such field emitters exhibit current non-uniformity. Since the emission current is extremely sensitive to the electrical field, the location, height, diameter, work function, and absorbance of the sharp objects will all have significant impact on the final emission current. Because the current is highly non-uniform, the total current cannot be too high without damaging a site with such a highest current density. Therefore, a good way to control the current uniformity is highly desirable.

It has also been discovered that densely packed carbon nanotubes used as field emitters on a cathode will actually shield the electric field from each other, thus reducing the emission current, and possibly resulting in a non-uniform emission of electrons from the cathode. Geometrically, a single Field Emitter (FE), can be simply thought of as a thin cylindrical tube, with an open or closed end. When this is immersed in a uniform potential region, for example between a planar anode and cathode, the shape of the FE body which is at ground potential, forces a distortion in the shape of the potential field. In particular, near the top of the FE, where the radius of curvature is much smaller than the length of the tube, the potential field is forced to conform to the radius and results in an amplified electric field at the surface of the FE at the top. As more and more FE are placed in close proximity with each other, the severe distortion of the potential field due to the curvature of the individual tubes is reduced, which in turn reduces the total amount of tunneling electron current. In the limit of an infinite number of tubes placed in contact with each other, the distortion is completely eliminated and one recovers the effect of a smooth, uniform and planar cathode, and at least 3-4 orders of magnitude increase in the applied potential is required to produce an amplified electric field due to the intrinsic geometry of single FE.

### BRIEF DESCRIPTION OF THE INVENTION

By patterning a catalyst layer in a micrometer scale and growing nanotubes on it, the emission area is formed as many small emitter islands. Each emitter island comprises finite nanotubes in a nominal density. Due to the gaps between emitter islands, relatively more nanotubes are exposed to the edge regions within the emitter, which effectively increases the average inter-spacing of nanotubes. The field shielding effect is significantly reduced this way.

Another advantage of the present invention is that since each micro-emitter emits electrons independently, a current limiting element, such as a thin resistive layer, can be added underneath each individual emitter to limit its current. The current limiting element forms a negative feedback loop to limit the maximum emitting current of each emitter. More uniform field emission can be achieved from a large area without forming local hot spots, which has a significant impact on improving device reliability and the maximum total emission current.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, the advantages thereof, reference is now made to the following descriptions taken in conjunction with the accompanying drawings, in which:

FIG. 1 illustrates an embodiment of the present invention;

FIG. 2 illustrates an alternative embodiment of the present invention;

FIG. 3 illustrates one embodiment of an exemplary shadow mask for producing a field emission cathode in accordance with an embodiment of the present invention;

FIG. 4 illustrates an alternative shadow mask for producing a field emission cathode in accordance with an embodiment of the present invention;

FIGS. 5-8 illustrate further alternative shadow masks for producing field emission cathodes in accordance with embodiments of the present invention;

FIGS. 9A-9F illustrate a process for manufacturing an embodiment of the present invention;

FIG. 10 illustrates a digital image of a cathode created in accordance with an embodiment of the present invention;

FIG. 11 illustrates a digital image of field emission from a cold cathode dot in accordance with an embodiment of the present invention;

FIG. 12 illustrates a digital image of field emission from a cold cathode dot in accordance with an embodiment of the present invention;

FIG. 13 illustrates a table showing current extracted from a diode pixel configured in accordance with an embodiment of the present invention;

FIG. 14 illustrates extracted current for single dot devices;

FIG. 15 illustrates a diode display apparatus configured in accordance with embodiments of the present invention;

FIG. 16 illustrates an x-ray device configured in accordance with embodiments of the present invention;

FIG. 17 illustrates a pixel diode configured in accordance with an embodiment of the present invention;

FIG. 18 illustrates a graph comprising extracted current comparing a multi-dot device to single dot devices;

FIG. 19 illustrates Opera simulation of electric field across cross-sections of circular emitters;

FIG. 20 illustrates another embodiment of the present invention; and

FIG. 21 illustrates a table showing current data for devices configured in accordance with an alternative embodiment of the present invention.

### DETAILED DESCRIPTION

In the following description, numerous specific details are set forth such as specific cathode configurations, etc. to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

Refer now to the drawings wherein depicted elements are not necessarily shown to scale and wherein like or similar elements are designated by the same reference numeral through the several views.

By patterning a catalyst layer in the micrometer scale on a substrate and growing nanotubes on it, the emission areas formed are small emitter sub-areas. Each emitter sub-area comprises finite nanotubes within a nominal density. Due to the gaps between such emitter islands, relatively more nanotubes are exposed to the edge regions of each of the emitters, which effectively increases the average inter-spacing of nanotubes. This results in a significant reduction of the electric field shielding effect. As a result, current uniformity is improved along with an improvement in the total current output. A further advantage of embodiments of the present invention is that it results in an emission of more current from a cold cathode CNT device without any increase in the total amount of emission area relative to previously employed configurations.

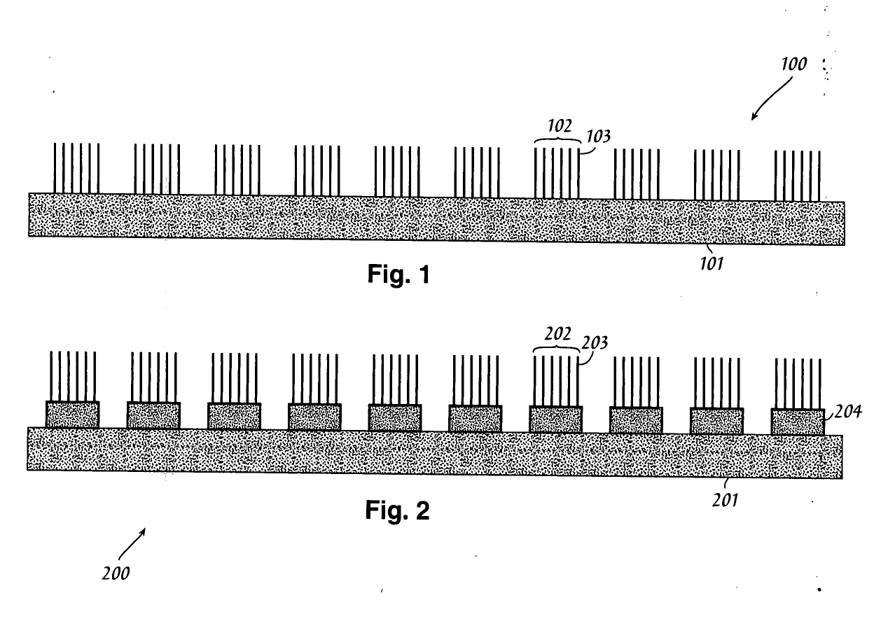

Referring to FIG. 1, there is illustrated a cold cathode 100 configured in accordance with one embodiment of the present invention. Various materials may be used for the substrate 101, such as silicon, glass, soda lime, titanium nitride, etc. Deposited on the substrate 101 are carbon nanotubes 103, may be partly in a relative vertical or partly random alignment. As will be described in further detail below, such carbon nanotubes 103 can be grown using a CVD (chemical vapor deposition) process from a catalyst material. However, other means for depositing carbon nanotubes may be employed, and such carbon nanotubes may not need to be deposited or grown in such a significantly vertical alignment, perpendicular to the substrate 101, to be effective. How the carbon nanotubes are deposited or grown on the substrate, or how such carbon nanotubes are aligned relative to the substrate, are not as important to the utility of the present invention as the manner in which such carbon nanotubes are patterned onto the substrate.

FIG. 1 illustrates cold cathode 100 in a side view, showing that groups of carbon nanotubes 102 are patterned onto the substrate 101 in a spaced-apart manner. In other words, the layer of carbon nanotubes 103 are not deposited on the substrate 101 as a single continuous layer. The interspersed regions of the substrate 101 where there are no carbon nanotubes results in more of the carbon nanotubes 103 deposited on the substrate 101 lying along an edge whereby such carbon nanotubes are not completely surrounded by other carbon nanotubes, and are thus more free from the effects of shielding from such accompanying carbon nanotubes. In one embodiment of the present invention, and as further described below, such groups 102 of carbon nanotubes 103 are configured as separate “dots” on the substrate surface 101.

FIG. 2 illustrates an alternative embodiment of a cold cathode 200. In this embodiment, “sub-areas” or “dots” 202 of carbon nanotubes 203 are deposited or grown on resistive elements 204, which are positioned on substrate 201. Such current limiting elements may be added underneath each individual field emitter “dot” to limit its current. The current limiting element forms a negative feedback loop to limit the maximum emitting current of each emitter 202. More uniform field emission may be achieved from a large area without forming local hot spots, with such resistive elements, which may have a significant impact on improving device reliability and the maximum total emission current.

FIG. 4 illustrates a top view of an exemplary cathode 400 showing a plurality of emitter “dots” or “sub-areas” 402 having a plurality of carbon nanotubes 403 formed thereon. For the sake of simplicity, only four such emitters 402 are shown on the cathode substrate 401.

To grow such carbon nanotubes in specific locations, such as the individual emitter dots, a shadow mask may be utilized for depositing a catalyst material onto the substrate 101, 201, 401. In the case of the cathode 400, such a shadow mask may actually look similar to the illustration in FIG. 4, where individual holes 403 are formed through a shadow mask 401, through which the catalyst material may be deposited onto a substrate below the shadow mask. Then, carbon nanotubes are grown from each of these catalyst dots.

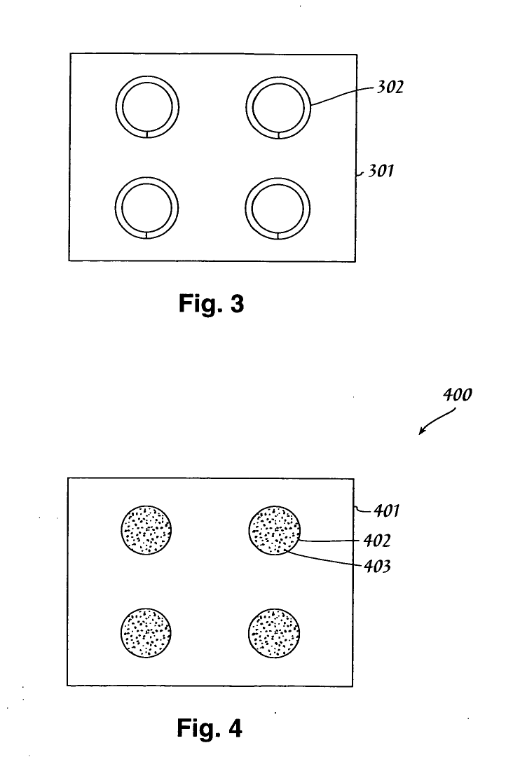

FIG. 3 illustrates an alternative embodiment of such a shadow mask 301 having ring-shaped holes 302 formed therethrough. Through such a shadow mask 301, the catalyst material will be deposited onto an underlying substrate, in a pattern so that each emitter dot on such substrate is formed by growing carbon nanotubes on each dot in a ring shape.

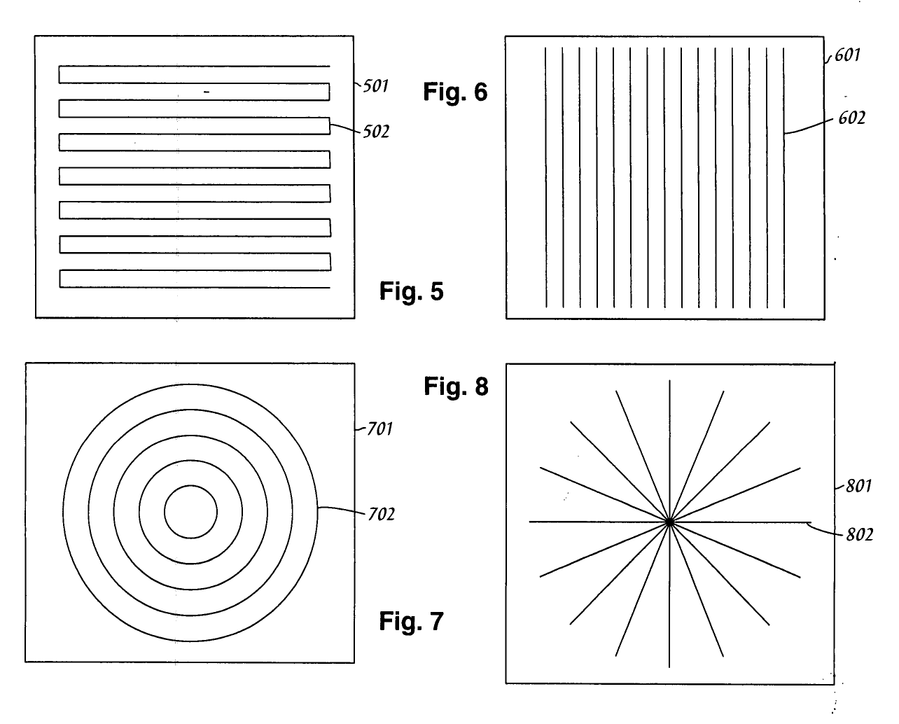

FIGS. 5-8 illustrate further alternative embodiments of shadow masks for depositing such a catalyst material onto a substrate in patterns so that the number of carbon nanotubes lying along an unobstructed edge is increased to reduce electric field shielding effects. The illustrations in FIGS. 5-8 also depict how a top view of such field emitters would look like once carbon nanotubes are deposited or grown in such patterns.

FIG. 5 illustrates a shadow mask 501 with a rectangular spiral slot 502 through which a catalyst material may be deposited onto an underlying substrate. The shadow mask 601 illustrated in FIG. 6 shows such slots 602 as parallel lines. The shadow mask 701 in FIG. 7 shows concentric rings 702 performing the catalyst layer, while shadow mask 801 in FIG. 8 illustrates slots 802 radiating out from a central location.

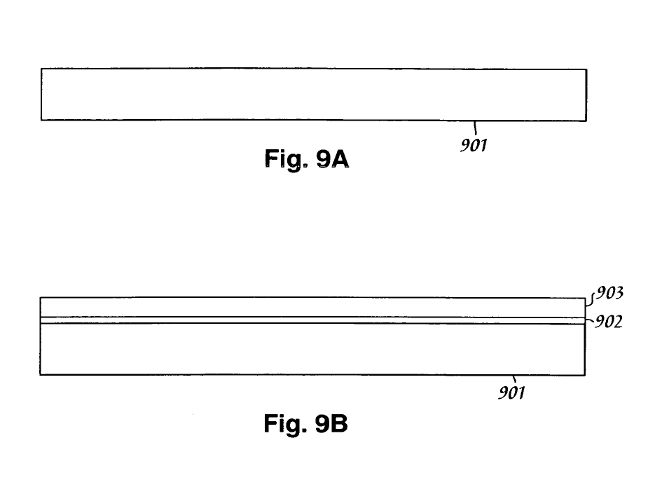

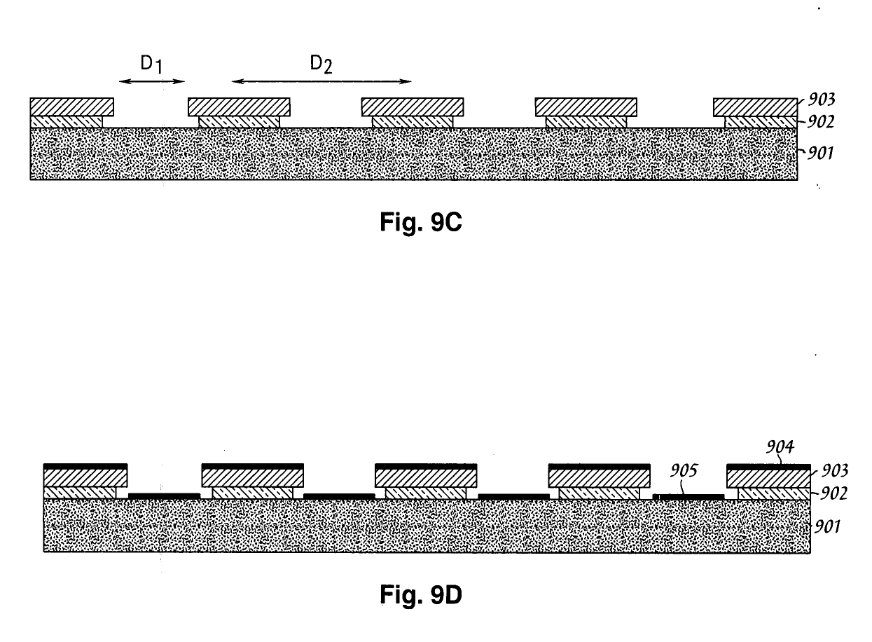

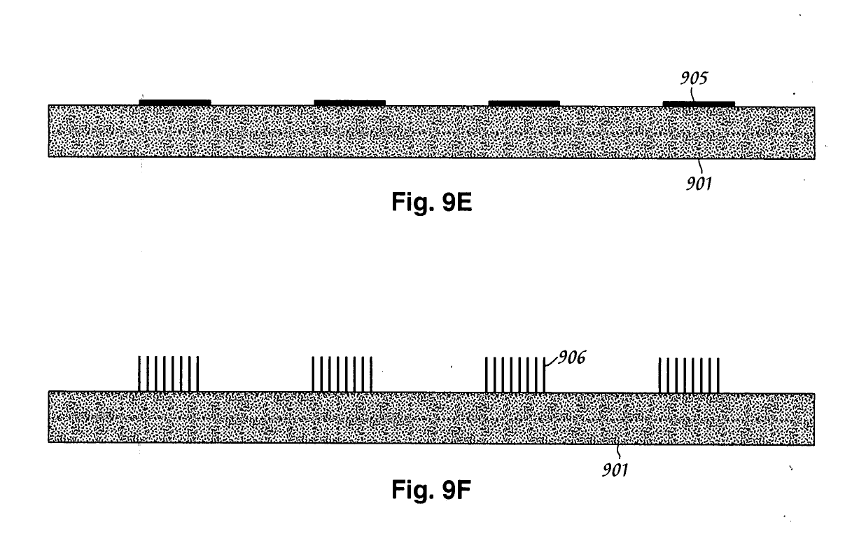

Referring now to FIGS. 9A-9F, there is illustrated a process for growing carbon nanotubes in accordance with one embodiment of the present invention. The process begins in FIG. 9A with a substrate 901, which may comprise a bare silicon wafer, or any other suitable substrate used for field emission cathodes. FIG. 9B illustrates a next step in the process whereby photoresist materials 902 and 903 are layered on top of substrate 901. Such photoresist layers may be spun onto the substrate 901 and then baked, or some other deposition process may be utilized. FIG. 9C illustrates a photolithography process of exposure and development of the photoresist layers 902 and 903 using conventional methods. Dimension D1 illustrates the size of a via or hole through which a catalyst layer will be deposited in a predetermined pattern onto the substrate 901. Such patterns are as previously discussed above with respect to FIGS. 1-8. Dimension D2 shows the via-to-via inter-spacing between the emitter dots, islands, or other portions of the cathode pattern. In the next step of the process illustrated in FIG. 9D, a catalyst material is deposited, such as using evaporation or sputtering. Such a catalyst may comprise a thin metal such as NiFe. A portion of the catalyst material will be deposited on top of the photoresist 903 islands as catalyst material 904 while the catalyst material that is deposited in each of the vias, or holes, or slots in the pattern specified is shown as catalyst material 905.

Thereafter, FIG. 9E illustrates that a lift-off process is utilized to remove the layers 902-904 using conventional methods, resulting in a patterned catalyst layer 905 on the substrate 901. It should be noted that a conductive layer could have optionally been deposited on substrate 901, so that the patterned catalyst layer 905 is deposited on the conductive layer. Thereafter, in FIG. 9F, carbon nanotubes 906 are grown from the catalyst pattern 905 resulting in a specified pattern of carbon nanotubes on substrate 901.

FIG. 15 illustrates an exemplary diode configuration of a display utilizing a cathode 1501 configured in accordance with any one of the various embodiments described above. Cathode 1501 comprises, as an example, substrate 901 with field emitter dots 906 thereon positioned a distance away from anode 1502. Anode 1502 may comprise a glass substrate 1503 with a phosphor material 1504. Conductive layers may be utilized within both of the cathode 1501 and anode 1502 in order to facilitate the application of an electric field supplied by a voltage source in order to result in sufficient electron emission from the cathode 1501 towards the anode 1502. Optionally, one or more grid electrodes may be utilized to further enhance the field emission properties.

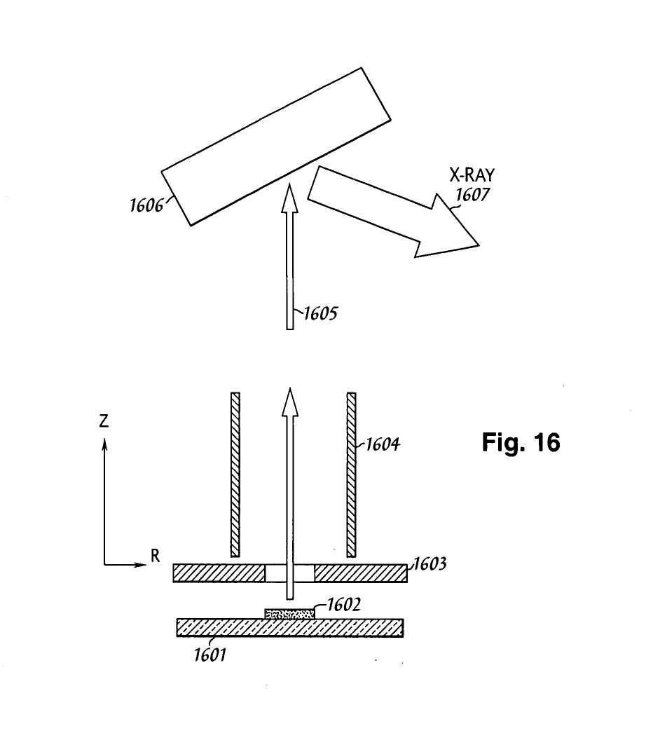

Referring to FIG. 16, there is illustrated an x-ray tube configured in accordance with an embodiment of the present invention utilizing any one of the field emission cathodes described above. An area of field emitting carbon nanotubes 1602, as configured in accordance with embodiments of the present invention is deposited on a substrate 1601, such as a conductive substrate (e.g., N-doped silicon). Under the influence of an electric field (at least 40 kV), carbon nanotubes will emit beams of electrons, as extracted by extractor plate 1603, which extracts electrons and allows their passage via an aperture in plate 1603. Focusing electrode 1604 may be used to help develop a spatially, well defined, electron beam 1605. The focused electron beam 1605 is directed toward accelerating anode 1606, which accelerates electrons coming through the focusing electrodes. The anode comprises a high Z material. The impact of the high energy electrons on the anode 1606 causes x-ray production 1607. Accelerating anode 1606 may be made from tungsten or molybdenum. Using a cold cathode to generate an electron beam, the lifetime of such an x-ray tube can be increased relative to cathodic filaments that generate electron beams upon heating.

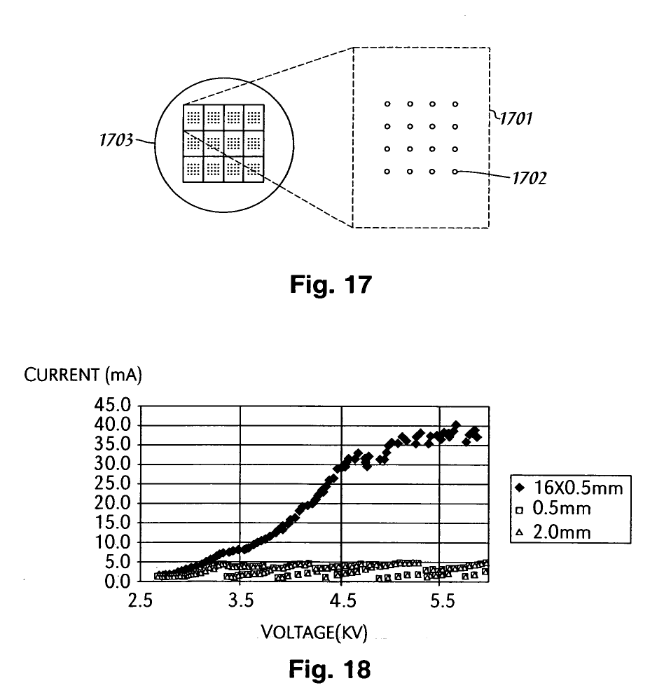

A silicon chip containing a single circular area of MWCNTs (multi-walled CNTs) can be used as a diode field emission device, generating <6 mA of current depending on the thickness (10-400 Å) and the diameter (30 μm-2.0 mm) of the NiFe catalyst used to deposit the MWCNTs. However, higher currents may be required for envisioned applications, prompting a utilization of the diode device to incorporate multiple MWCNT dots with an additive increase in overall emission current. FIG. 17 illustrates a top view of an exemplary pixel diode 1701 containing sixteen MWCNT dots 1702 arranged in a 4×4 array. The pixel 1701 is shown as being a portion of a cathode 1703 with a plurality of pixels 1701. The multiple MWCNT dots provide higher current density than a corresponding single dot investigated previously. Furthermore, the area of the single dot is equivalent to that of the 4×4 array of dots, allowing for a comparison of the effect of multiple small emission areas to one equivalent continuous emission area. As an example, sixteen 0.5 mm dots have the same area as a single 2 mm dot, but are significantly more effective a field emitters. The device in FIG. 17 may be produced by shadow mask sputtering of a NiFe (8:2) target onto a silicon substrate; the catalyst thickness (124±4 Å) and composition (NiFe 8:2) may be determined by Auger Electron Spectroscopy.

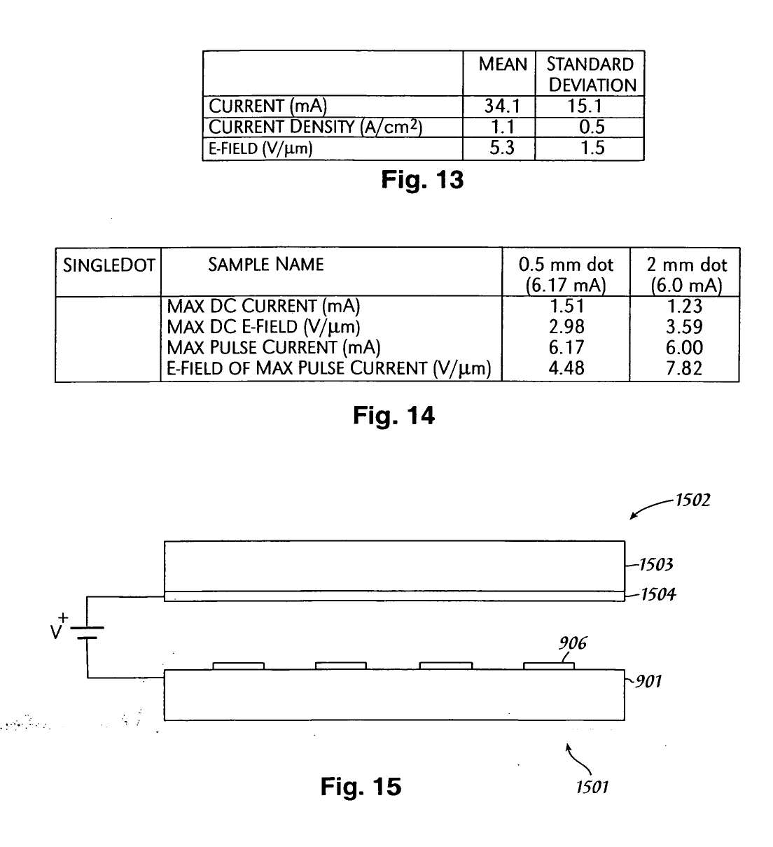

A CVD (chemical vapor deposition) reactor may be used to deposit MWCNTs on the sixteen catalyst areas of a device using standard growth protocols previously established for the single dot system (750° C., H₂ (336 sccm), CH₄ (34 sccm) C₂H₈ (20 sccm). The multidot device may then be subjected to pulsed diode field emission testing and compared to control (0.5 mm and 2.0 mm) single dot diodes, and tested under identical conditions. FIG. 13 illustrates a table indicating that a 34±15 mA (n=7) of current may be extracted from a multidot device, compared to 6 mA for a single dot device, as noted in the table illustrated in FIG. 14 showing data for tests performed on two single dot devices.

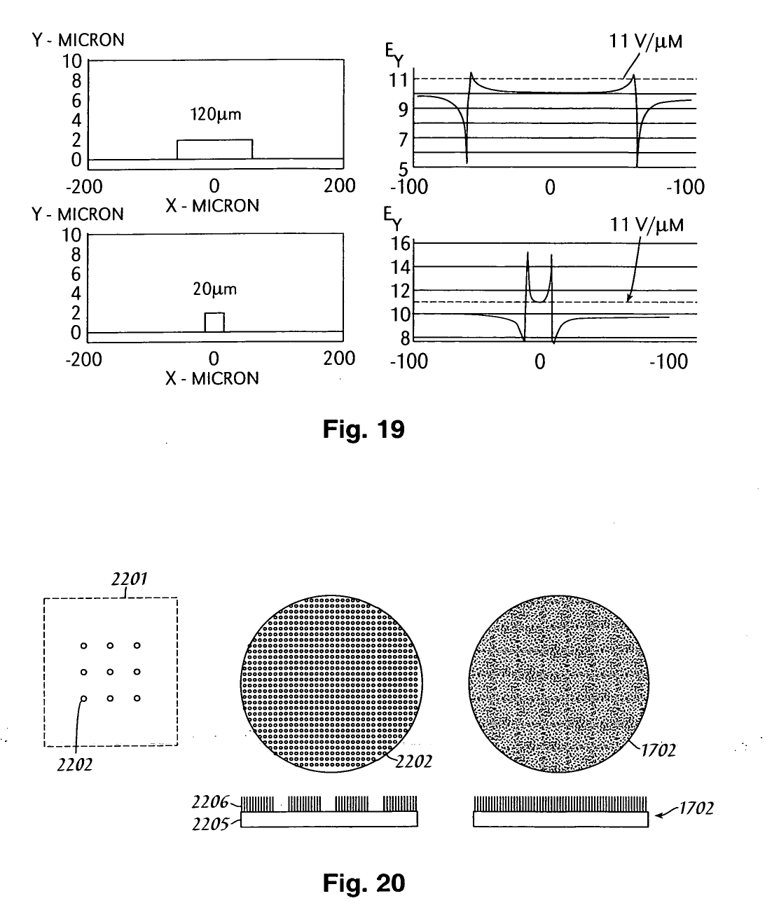

Thus, as shown in FIG. 18, CNT-based diodes consisting of multiple circular micron-sized emission areas (e.g., sixteen 0.5 mm dots) provide greater current than that of a single continuous emission area (e.g., single dots of 0.5 mm or 2.0 mm). This effect partly arises from intra-dot shielding of CNTs, which is supported by Opera simulations of the electric field experienced across a cross-section of the circular emitters. The modeling illustrated in FIG. 19 indicates that the maximum and average field strengths encountered by smaller emission areas are greater than that experienced by larger emission areas, with the greatest electric field observed at the edges of the emission area and the smallest electric field closer to the center of the emission area where electric field shielding is greatest. Thus, a higher current may be extracted from smaller circular emission areas at a given voltage due to this greater electric field enhancement.

FIG. 20 illustrates an alternative embodiment of the present invention. The field enhancement effect is further utilized and a more uniform CNT emission source constructed by the assembly of similarly sized multi-dot CNT emission areas 2202 comprising themselves an array of multiple micron-sized smaller dots 2206. The intradot CNT shielding across the center of the emission area is further reduced and a larger electric field produced, thereby leading to improved FE uniformity across the emission area and higher emission current.

Such multi-dot array devices 2206 may be constructed on substrates 2205, using microfabrication techniques as described above, as a series of nine (or some other number) circular areas of 1 mm diameter, in a 3×3 configuration for a pixel 2201, where each dot consists of an array of 845×20 μm diameter individual dots, spaced 10 μm apart. Note, the design may comprise non-circular sub-areas instead of circular dots, different numbers of dots in the array, and the spacing parameters may be modified to other suitable dimensions. A NiFe catalyst may be deposited across the individual 20 μm diameter dots by PE-sputtering deposition, and a CVD reactor may be used to grow MWCNTs within each area using the standard growth protocols previously established for the single dot and multidot systems (750° C., H₂ (336 sccm), CH₄ (34 sccm) C₂H₈ (20 sccm)).

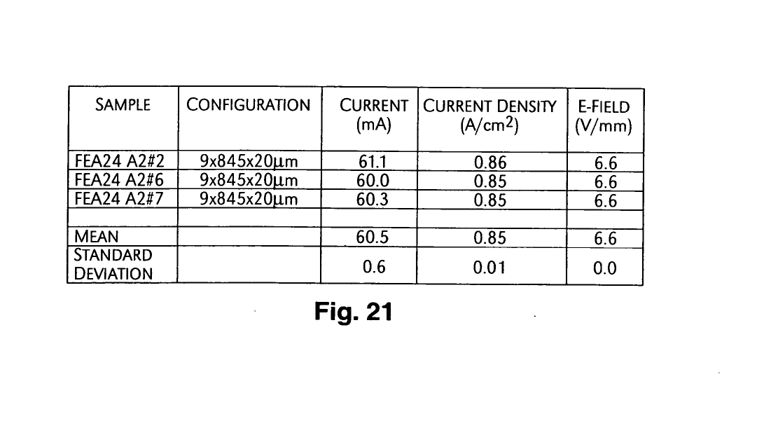

The devices are highly effective pulsed FE diodes, affording 61±1 mA of current, which corresponds to 0.9 A cm⁻² current density for a 9×845×20 μm array, as summarized in the table shown in FIG. 21. The electric fields employed to extract the maximum current from the devices are substantial, but similar to that employed for the previously described multidot diode; additionally, the current obtained from single dot diodes at this field is less (˜6 mA), as described previously. These devices are also highly consistent in their device-to-device FE performance, with less than a 2% standard deviation in pulsed current. The improvement in emitted current and reproducibility arises from the multidot array configuration of the CNT emitters which reduces intra-dot CNT shielding.

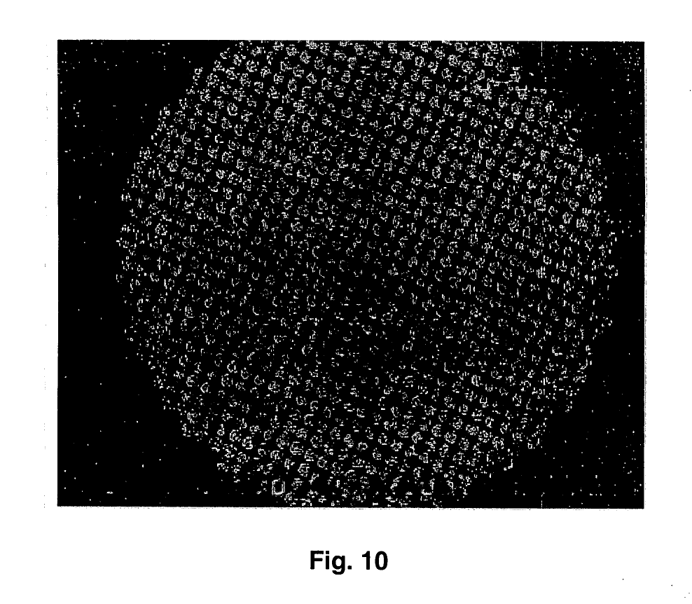

FIG. 10 illustrates a digital image of an exemplary field emission cathode configured in accordance with the embodiment of FIG. 20 showing a multitude of field emitter dots. This is a 100× magnification of the picture of a sample with CNTs grown in a specific orientation. In this example, the catalyst is dispersed in a uniform matrix that covers a 1 mm diameter region. The size of the catalyst is 20 μm and the spacing between catalysts is 10 μm. A total number of catalysts sub areas within a 1 mm dot is 845. The magnified image not only shows the separate catalyst regions but also the CNTs growing on each of the regions.

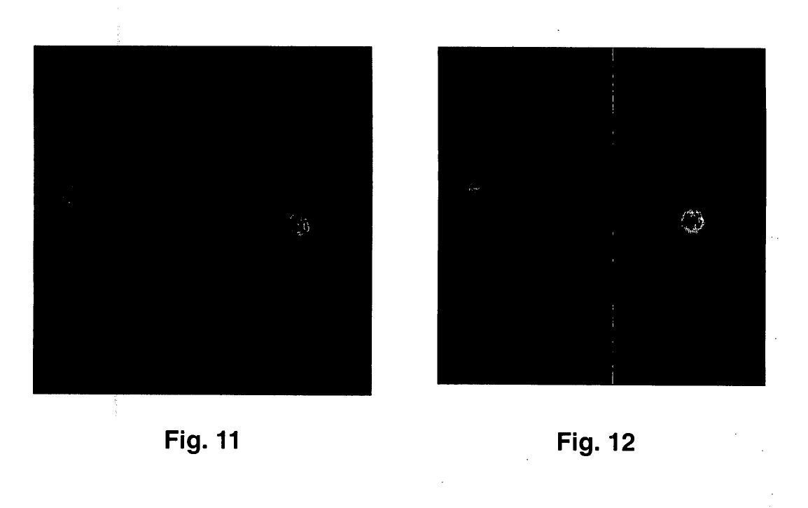

FIG. 11 illustrates an image of the electrons emitted from the 1 mm dot described in FIG. 10. The image is generated when electrons from the sample impinge the surface of a phosphor held close to the surface of the sample (˜1 mm separation). The energetic electrons strike the phosphor and part of the energy is converted into visible photons which are captured by a recordable, imaging system. In particular, this image shows that the electrons are not emitted uniformly across the sample, but in fact are located on an annulus, within the 1 mm dot. A darker central region is noticeable in FIG. 11.

FIG. 12 illustrates an extension of the image seen in FIG. 11, but at higher electron energy. Here the captured image is brighter but the annulus is still visible.

Various embodiments of the present invention having been thus described in detail by way of example, it will be apparent to those skilled in the art that variations and modifications may be made without departing from the invention. The invention includes all such variations and modifications as fall within the scope of the appended claims.

What is claimed is:

1. A field emission cathode comprising:
a substrate; and
a plurality of field emitters arranged on the substrate in a spaced apart configuration, each of the plurality of field emitters comprising nanotubes, wherein all of the plurality of field emitters are simultaneously activated for emission of electrons.

2. The field emission cathode as recited in claim 1, wherein spacing between the plurality of field emitters is greater in dimension than a cross-section of any of the plurality of field emitters.

3. The field emission cathode as recited in claim 1, wherein the plurality of field emitters are configured on the substrate as a plurality of dots.

4. The field emission cathode as recited in claim 1, further comprising a resistive layer between each of the plurality of field emitters and the substrate.

5. The field emission cathode as recited in claim 1, wherein the nanotubes are carbon nanotubes.

6. The field emission cathode as recited in claim 1, wherein spacing between the plurality of field emitters is greater than a height of the nanotubes.

7. A component in a field emission cathode comprising a plurality of pixels individually controllable from each other, the pixel comprising a plurality of field emitters mounted on a substrate in a spaced apart configuration, wherein the plurality of field emitters further comprise CNTs, and all of the plurality of field emitters are simultaneously activated to emit electrons.

8. The component as recited in claim 7, wherein the plurality of field emitters are configured on the substrate in a pattern of dots spaced apart from each so that there are no CNTs in between the dots of field emitters.

9. The component as recited in claim 8, further comprising a resistive layer between each of the field emitters and the substrate.

10. The component as recited in claim 8, wherein space between the dots is greater in length than diameters of the dots.

11. The component as recited in claim 7, wherein spacing between the plurality of field emitters is greater than a height of the nanotubes.

12. A pixel in a field emission cathode comprising a plurality of sub-areas spaced apart from each other on a substrate, each sub-area further comprising an array of islands of nanotubes, the islands physically separated from each other so that there are no nanotubes on the substrate between the islands.

13. The pixel as recited in claim 12, wherein the nanotubes are carbon nanotubes.

14. The pixel as recited in claim 12, wherein the islands are 20 μm in diameter with 10 μm spacing between the islands.

15. The pixel as recited in claim 14, wherein the sub-areas are 1 mm in diameter with spacing between the sub-areas greater than 1 mm.

16. The pixel as recited in claim 12, wherein a sum of lengths of external boundaries of the islands is greater then a length of an external boundary for its respective sub-area.

17. An electron beam producing system comprising a cathode and an anode positioned a distance from each other, further comprising a plurality of field emitter regions mounted on a substrate in a spaced apart configuration, each of the plurality of field emitter regions further comprising an array of field emitter dots spaced apart from each other to decrease a shielding effect among nanotubes mounted on the dots.

18. The system as recited in claim 17, wherein the array of field emitter dots comprises a substrate having a plurality of spaced apart regions, each having nanotubes mounted thereon.

19. The system as recited in claim 18, wherein the array of field emitter dots result in more nanotubes positioned along edges of the dots then nanotubes positioned along edges of its respective field emitter region encompassing the array of field emitter dots.

20. The system as recited in claim 17, wherein an electron beam is formed from the field emitter dots moving in a direction from the cathode to the anode.

21. The system as recited in claim 20, wherein the electron beam is formed and accelerated by applying a sufficiently high potential between the anode and cathode so that the electron beam strikes the anode and forms x-rays.

22. The system as recited in claim 21, wherein the anode comprises a high Z material, and wherein the potential between the anode and cathode is at least 40 kV.
